(19) United States
(12) Patent Application Publication
(10) Pub. No.: US 2006/0294350 A1
(43) Pub. Date: Dec. 28, 2006

(54) Process for controlling service offers based upon network connections during out of box experience

(76) Inventors: Fengshu Yang, Austin, TX (US); Brent Gaskamp, Austin, TX (US); James A. Howell JR., Georgetown, TX (US)

Correspondence Address: HAMILTON & TERRILE, LLP, P.O. BOX 203518, AUSTIN, TX, 78720, US

(21) Appl. No.: 11/159,053

(22) Filed: Jun. 22, 2005

(51) Int. Cl. G06F 15/177

(52) U.S. Cl. 713/1

(57) ABSTRACT

A method of controlling an out of box experience for an information handling system which includes determining whether a service connection is present and presenting a customized out of box experience based upon whether a service connection is present is disclosed.

### BACKGROUND OF THE INVENTION

1. Field of the Invention

The present invention relates to build to order systems, and more particularly, to services controlling the out of box experience (OOBE) for build to order systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Known web based on-line stores provide a customer with an ability to select a base information handling system, customize the system and price it. Such an on-line store focused initially upon the bare necessities. That is, build a system and get a price. A configurator allowed the customer to customize and procure the system on-line. The configurator allowed the customer to select a given system model and to customize the system according to the user selected options. Such a configurator was most well received by knowledgeable customers, that is, those who were very self-sufficient without the assistance of a sales representative.

Known on-line stores included a web objects based application providing the capability to custom configure and order a particular system. The initial on-line store application offered customers the ability to select and price key system options, the ability to include multiple systems on a single order, and the ability to provide information necessary for the placement of a standard system order.

The capability to self-select system options and then price the options was provided via an on-line configurator. This configurator enabled customer selection of key, system-defining components from a display of available system options for a chosen system. The display of available options included the presentation of a “delta” price, wherein a change in system price was affected by selection of an option. The configurator provided the ability to update overall system priced based upon selections made. The capability to include multiple items in a single order was afforded by the presence of a “shopping cart,” wherein the shopping cart represents an equivalent to the traditional shopping cart. The shopping cart enabled customers to group disparate systems together as an order, as well as specify a quantity for each individual system to be included on the order. Furthermore, the capability to provide customer-specific information required for the placement of a standard order was provided via an on-line “checkout,” the checkout including essentially a form for facilitating the capture of requested and required information. The checkout form included simple logic rules to assure entry of the required fields.

After a system is ordered, the customer may be provided the opportunity to order a particular service such as Internet service. When the customer indicates a desire to order such a service, then the on-line store transfers (i.e., links) the customer to the web site for the particular service in which the customer is interested. Often the web site for the service provides its own look and feel, different from the look and feel of the on-line store. Also, the customer experience changes with the link to the web site of the service provided. Also, after the customer has transferred to the new web site, the original on-line store no longer has control or can access the information provided by the customer.

Known out of box experience modules, such as those included within operating systems available from Microsoft, provide mechanisms for adding service providers such as internet service providers (ISP's) to their standard out of box experience. These mechanisms do not provide standard processes for customizing the out of box experience outside of branding or the manual adding/removing standard pages.

### SUMMARY OF THE INVENTION

In accordance with the present invention, customizing service access offers based upon network connections occurring during an out of box experience is disclosed.

In one embodiment, the invention relates to a method of controlling an out of box experience for an information handling system which includes determining whether a service connection is present and presenting a customized out of box experience based upon whether a service connection is present.

In another embodiment, the invention relates to an apparatus for controlling an out of box experience for an information handling system which includes means for determining whether a service connection is present and means for presenting a customized out of box experience based upon whether a service connection is present.

In another embodiment, the invention relates to an information handling system apparatus for controlling an out of box experience for an information handling system which includes a processor, a memory coupled to the processor and an out of box experience module stored on the memory wherein a customized out of box experience is presented based upon whether a service connection is present. The out of box experience module determines whether a service connection is present.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows access to the on-line store via the Internet using a computer system.

FIG. 3 shows a system block diagram of an information handling system.

FIG. 4 shows a flow chart for a process for controlling service offers based upon network connections detected during execution of an out of box experience module.

FIG. 5 shows an example screen presentation of a customized service offer.

FIG. 6 shows another example of a screen presentation of a customized service offer.

### DETAILED DESCRIPTION

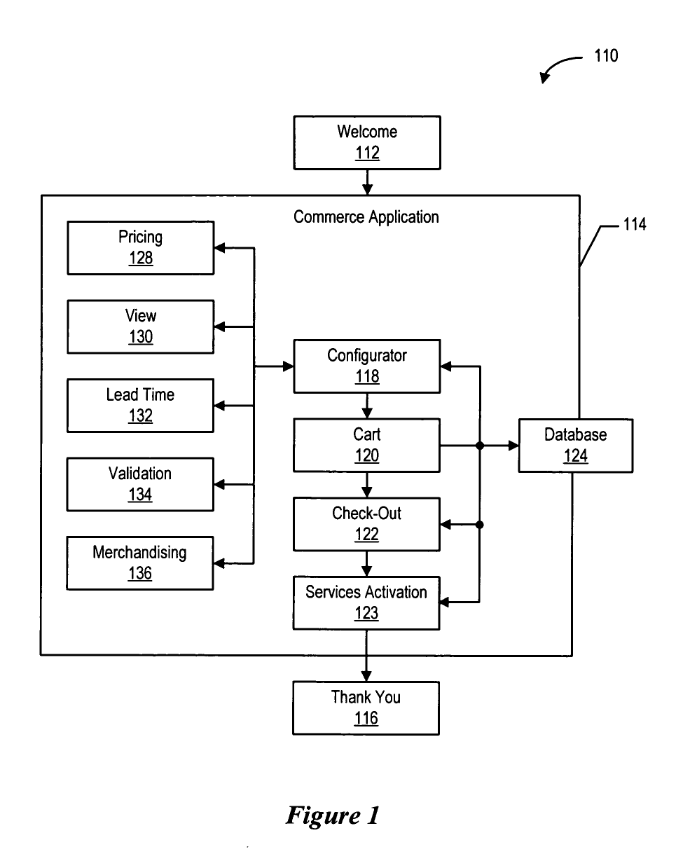

Referring to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122 and services activation module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and services activation module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the services activation module 123 presents a services activation page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, a customer is transferred to a services activation page in which the customer is provided an opportunity to activate various services such as internet service or content services such as music services. After completion of the services activation module 123, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and services activation module 123 are each part of the commerce application 114 and interact with the database 124. For example, with the shopping cart 120, additional merchandising information associated with a particular system which has been configured and placed in the shopping cart by an on-line store customer can be provided.

Also for example, various services may be provided for order by the customer by the services activation module 123 based upon the type of system ordered as well as components that are included within the system ordered. Additionally, by providing the services activation module within the commerce application 114, the customer continues the experience a similar customer experience and the system provider is able to use the information from the database 124 and to maintain control over the customer contact. By maintaining control over the customer contact the system provider is able to determine what services are activated and to maintain accurate and up to date records of the service activation.

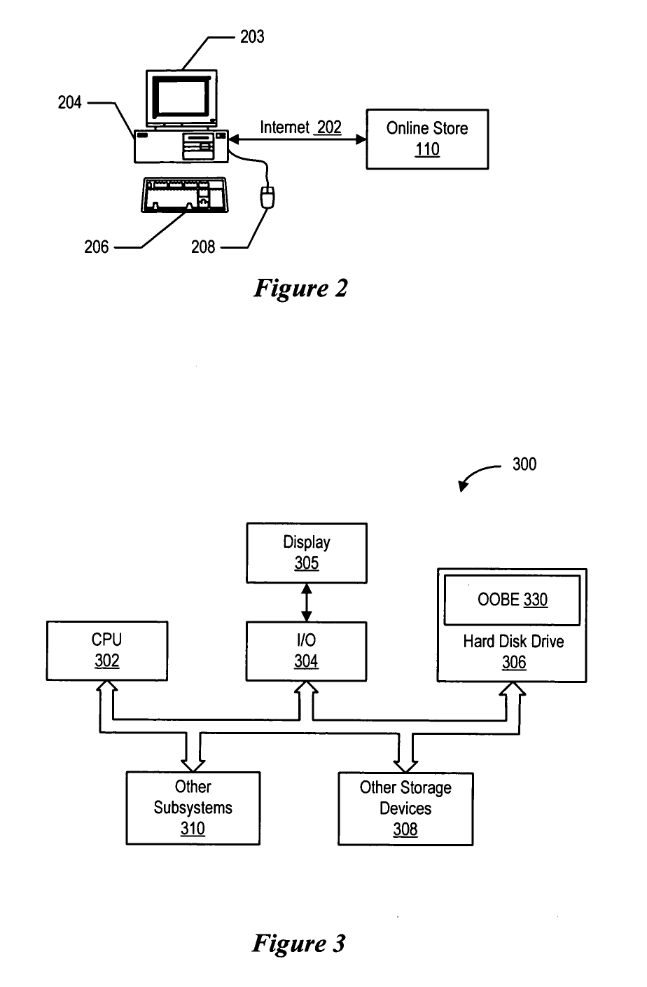

Referring to FIG. 2, a customer can access the on-line store 110 using any suitable computer equipment 200, via the Internet 202. The computer equipment 140 may include a display 203, computer 204, keyboard 206, and pointing device 208. Display 203 is used for displaying the various pages of the on-line store while a customer is using the on-line store.

Referring briefly to FIG. 3, a system block diagram of an information handling system 300 is shown having features thereof configured in accordance with the on-line store 110 as discussed. The information handling system 300 includes a processor 302, input/output (I/O) devices 304, such as a display, a keyboard, a mouse, and associated controllers, non-volatile memory 306 such as a hard disk drive, and other storage devices 308, such as a DVD, CDROM or floppy disk drive and other memory devices, and various other subsystems 310, all interconnected via one or more buses 312. The non-volatile memory 306 may include an out of box experience module 330 which executes the first time the information handling system 300 is powered on by a customer.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

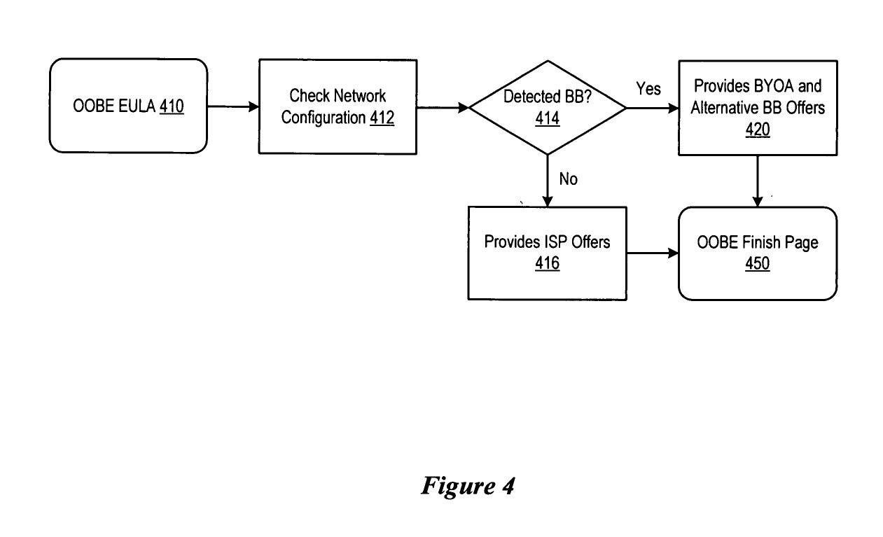

FIG. 4 shows a flow chart of a system 400 for controlling an out of box experience. In general, OEM manufacturers of certain operating systems may have the ability to modify the OOBE modules of the operating system. The OEM manufacturers can thus provide their customers different software offers, such as ISP offers, based on the system network connection status. If the information handling system does not have an existing broadband connection, the OOBE module can show both broad band offers and dial up offers. If the information handling system already has a broad band connection, then the OOBE module can display bring your own access (BYOA) ISP offers and other alternative broad band offers. The OOBE module might measure the detection speed of the broad band connection to provide the OEM manufacturer with the ability to offer the customer with higher speed broad band options.

The OOBE module can provide a significant impact on the OEM manufacturer's ability to offer additional ISP offers or services and can help mitigate a decline in registration rates form narrow band connections by growing other ISP revenues. Additionally, the OOBE module provides a better customer experience and a full selection of choice that are tailored to the customer's particular needs.

The OOBE module detection mechanism assists in understanding how and what to offer customers when the OOBE flow is removed from the operating system. The OOBE module can continue to use and optimize this or a similar mechanism to detect the network connection at the first execution of the operating system boot to the desk top stage and provide different software offers based on the network configuration.

Post OOBE, the information obtained by the OOBE module allows the OEM manufacturer to properly name the icons that are presented to the user based upon usage models. (E.g., an AOL icon might become an AOL for broadband icon if a broadband connection is detected.) The OEM manufacturer can also use this information to offer more relevant services to a broad band user base (e.g., on-line gaming, video or music downloads, voice over IP, etc.) or to the narrow band user base. The information obtained by the OOBE module thus provides the OEM manufacturer with the ability to monetize the desktop of the information handling system.

More specifically, the OOBE module 330 starts execution by generating an out of box experience (OOBE) end user license agreement (EULA) at step 410. The OOBE module 330 then checks whether and what kind of network connection is present at step 412 and determines whether a broad band network connection is present at step 414. The network connection may be determined either manually by user input of automatically by, for example, accessing the operating system information on network connection speeds.

If a broad band network connection is present, then the OOBE module 330 provides BYOA and alternative broad band offers at step 420. If a broad band network connection is not present, then the OOBE module provides ISP offers at step 430. After either step 420 or step 430, the OOBE module 330 then presents an OOBE finish page at step 450.

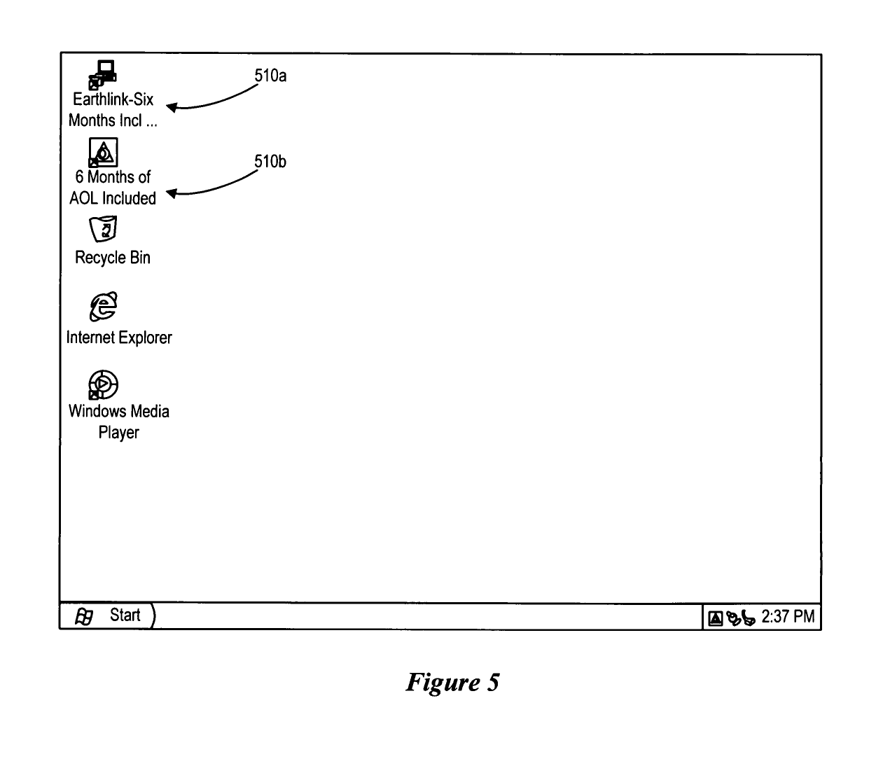

Referring to FIG. 5, a screen presentation of a customized service offer based upon OOBE detected settings is shown. More specifically, when the out of box experience module starts executing, the module generates a screen presentation which includes certain service offers 510a, 510b based upon the type of network connection the OOBE module detects.

Additionally, the particular screen presentation that is presented may include services that were or were not selected during the configuration of the information handling system 300. For example, if a user did not select any internet connection, then the presentation may query a customer about whether the customer would like to easily configure an internet connection or whether the customer would like to configure an internet connection at a later time. This customization may also vary the length of service membership to which the user is entitled based upon the out of box experience customization.

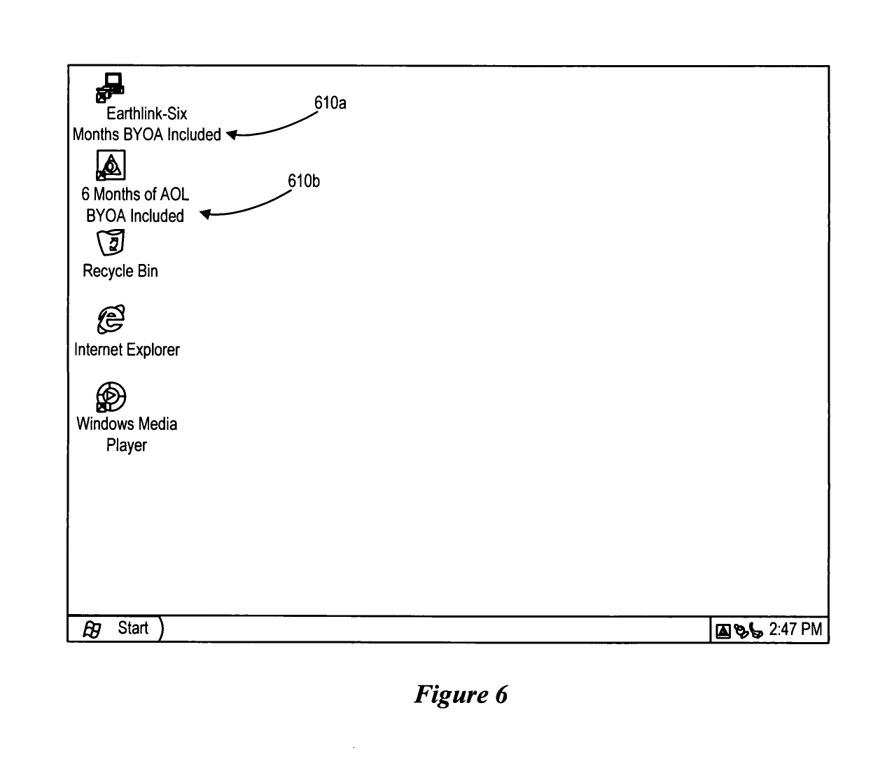

Referring to FIG. 6, another screen presentation of a customized service offer is shown. More specifically, if the OOBE module detects that a broad band connection is present, then the screen presentation can present icons that display bring your own access (BYOA) ISP offers and other alternative broad band offers

### OTHER EMBODIMENTS

Other embodiments are within the following claims.

For example, the services activation module 123 which interacts with the database 124 may be used by a telephone sales person when a system is being ordered via the telephone. In this situation, the information that is derived by the telephone sale person during a customer interview is then used to provide the customer with the option of services activation. Accordingly, the customer continues the experience a similar customer experience and the system provider is able to use the information from its database and to maintain control over the customer contact. By maintaining control over the customer contact the system provider is able to determine what services are activated and to maintain accurate and up to date records of the service activation.

Also for example, while specific services are identified as being activated by the services activation module, other services or benefits may also be activated by the services activation module.

Also for example, the OOBE module can detect other service settings. For example, the OOBE module could detect whether a satellite connection is present and if so tailor any offers that are presented on the desktop based upon the satellite connection.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method of controlling an out of box experience for an information handling system comprising:
determining whether a service connection is present; and,
presenting a customized out of box experience based upon whether a service connection is present.

2. The method of claim 1 further comprising
the customized out of box experience is further customized based upon services that are ordered when the information handling system is configured.

3. The method of claim 2 wherein
the services that are ordered include internet services.

4. The method of claim 1 wherein
the presenting allows a user to activate services based upon the determining whether a service connection is present.

5. The method of claim 1 wherein
the determining further detects a type of service connection; and,
the customized out of box experience is further customized based upon the type of service connection.

6. The method of claim 1 wherein
the service connection includes an internet service connection.

7. An apparatus for controlling an out of box experience for an information handling system comprising:
means for determining whether a service connection is present; and,
means for presenting a customized out of box experience based upon whether a service connection is present.

8. The apparatus of claim 7 wherein
the customized out of box experience is further customized based upon services that are ordered when the information handling system is configured.

9. The apparatus of claim 8 wherein
the services that are ordered include internet services.

10. The apparatus of claim 7 wherein
the presenting allows a user to activate services based upon the determining whether a service connection is present.

11. The apparatus of claim 7 wherein
the means for determining detects a type of service connection; and,
the customized out of box experience is further customized based upon the type of service connection.

12. The apparatus of claim 7 wherein
the service connection includes an internet service connection.

13. An information handling system apparatus for controlling an out of box experience for an information handling system comprising:
a processor;
a memory coupled to the processor;
an out of box experience module stored on the memory, the out of box experience module
determining whether a service connection is present; and,
presenting a customized out of box experience based upon whether a service connection is present.

14. The information handling system of claim 13 wherein
the customized out of box experience is further customized based upon services that are ordered when the information handling system is configured.

15. The information handling system of claim 14 wherein
the services that are ordered include internet services.

16. The information handling system of claim 13 wherein
the presenting allows a user to activate services based upon the determining whether a service connection is present.

17. The information handling system of claim 13 wherein
the determining further detects a type of service connection; and,
the customized out of box experience is further customized based upon the type of service connection.

18. The information handling system of claim 13 wherein
the service connection includes an internet service connection.
